(19) United States
(12) Patent Application Publication
(10) Pub. No.: US 2015/0363361 A1
(43) Pub. Date: Dec. 17, 2015

(54) Method for Kernel Correlation-Based Spectral Data Processing

(71) Applicant: Mitsubishi Electric Research Laboratories, Inc., Cambridge, MA (US)

(72) Inventor: Andrei Kniazev, Cambridge, MA (US)

(21) Appl. No.: 14/305,637

(22) Filed: Jun. 16, 2014

(51) Int. Cl. G06F 17/16; G06F 17/50; G06F 17/18

(52) U.S. Cl. CPC G06F 17/16; G06F 17/18; G06F 17/5009

(57) ABSTRACT

Data points of input data are processed by first determining a Laplacian matrix for the data. A spectrum of the Laplacian matrix includes an attractive spectrum of positive eigenvalues, a repulsive spectrum of negative eigenvalues, and a neutral spectrum of zero eigenvalues. An operation for the processing is determined using the Laplacian matrix, using information about the attractive spectrum, the repulsive spectrum, and the neutral spectrum, wherein the information includes the spectra and properties derived from the Spectra. Then, the operation is performed to produce processed data.

### RELATED APPLICATIONS

This Application is related to MERL-2727, A Method for Anomaly Detection in Time Series Based on Spectral Partitioning, co-tiled herewith, and incorporated by reference. Both Applications deal with processing data using similarity matrices to form graph Laplacian matrices.

### FIELD OF THE INVENTION

The fields of the invention are data analysis and signal processing, and more particularly partitioning data points acquired from sensors in industrial applications into clusters and graph based processing of signals, such as signal denoising.

### BACKGROUND OF THE INVENTION

Data Clustering via Spectral Partitioning

The rapidly decreasing costs of data acquisition, communication, and storage technologies have made it economically feasible to accumulate vast amounts of data. One of the uses of such data is the automated discovery of anomalous conditions that might signify a fault in mechanical or electrical equipment. Such faults can include loose or broken components, incorrect sequence of operations, unusual operating conditions, etc. In most cases, the immediate discovery of such anomalous conditions is very desirable, in order to ensure worker and customer safety, minimize waste of materials, or perform maintenance in order to avoid even bigger, catastrophic failures. The normal operating limits might be obtained by means of a data-driven approach, where data variables are measured under certified normal conditions, and a descriptor of the normal operating ranges is extracted from this data.

Data clustering via spectral partitioning is a state-of-the-art tool in anomaly detection, which is known to produce high quality clusters. The computational part: of spectral partitioning is a numerical solution of an eigenvalue problem. In multivariate statistics and the clustering of data, spectral partitioning techniques make use of a spectrum (eigenvalues) of a similarity or related matrix of the data to perform dimensionality reduction before clustering in fewer dimensions. The similarity matrix is provided as an input and consists of a quantitative assessment of the relative similarity of each pair of points in the dataset. Important applications of graph partitioning include scientific computing, e.g., task scheduling in multi-processor systems. Recently, the graph partition problem has gained importance due to its application for clustering and detection of cliques in social and biological networks.

Given a set of N data points, the similarity matrix (two-dimensional array) may be defined as an N×N matrix A, with entries aᵢⱼ that represent a measure of the similarity between points in the set indexed by i and j. A similarity matrix may be viewed as a matrix of scores that represent the similarity between of data points. Similarity matrices are commonly determined from their counterparts, distance matrices. The distance matrix is a matrix containing the distances, taken pairwise, of a set of points. The general connection is that the similarity is small if the distance is large, and vice versa.

Commonly, the data clustering problem is formulated as a graph partition problem. The graph partition problem is defined on data represented in the form of a graph G=(V, E), with N vertices V and M edges E such that it is possible to partition G into smaller components with specific properties. For instance, a k-way partition partitions the vertex set into k smaller components. A good partition is defined as one in which the number of edges between separated components is small. Uniform graph partition is a type of graph partitioning problem that consists of partitioning a graph into components, such that the components are of about the same size and there are a relatively small number of connections between the components.

The graph adjacency matrix A has entries aᵢⱼ=wᵢⱼ≧0 where wᵢⱼ≧0 is a weight of an edge between nodes i and j. A degree matrix D is a diagonal matrix, where each diagonal entry of a row i represents the node degree of node i. The Laplacian matrix L of the graph is defined as L=D−A. An eigenvector of L corresponding to second smallest eigenvalue λ≧0 of L, called the Fiedler vector, bisects the graph G into only two clusters based on the sign of the entries of the eigenvector.

FIG. 1 shows one example of the prior au spectral bisection. The graph in FIG. 1 is disconnected, with two sub-graphs 101 G(1, 2, 3) and 102 G(4, 5). All visible edges have the same weight 1. The graph Laplacian 103 is a 5-by-5 matrix.

The full eigenvalue decomposition of L is given by 104. Every column of the matrix V is an eigenvector, corresponding to an eigenvalue given in E. For example, the smallest eigenvalue 105 is zero. The second smallest eigenvalue λ.

106 is also zero in this example, with the corresponding eigenvector 107. The first three components Node id 1, 2, and 3 of the eigenvector 107 are zeroes, while the last two, with Node id 4 and 5, are negative, which suggests to bisect the graph into sub-graphs 101 G (1, 2, 3) and 102 G(4, 5). Since the sub-graphs 101 G (1, 2, 3) and 102 G(4, 5) are not connected to each other, the bisection is optimal.

Almost the same graph as in FIG. 1 is shown in FIG. 2, but only with a one new edge 211, also having the weight 1. The updated graph Laplacian 203 is still a 5-by-5 matrix, but with some updated entries. The full eigenvalue decomposition of L is given by 204. Every column of the matrix V is an eigenvector, corresponding to an eigenvalue given in E. For example, the smallest eigenvalue 205 is still zero, as always expected for the graph Laplacian. The second smallest eigenvalue A 206 is nonzero in this example, with the corresponding eigenvector 207. The first three components Node id 1, 2, and 3 of the eigenvector 207 are positive, while the last two, with Node id 4 and 5, are negative, which suggests to bisect the graph into sub-graphs 101 G (1, 2, 3) and 102 G(4, 5). Thus, the spectral clustering in this example uses the Fiedler vector 207 to bisect: the graph into two balanced components, one component 101 with vertices {1, 2, 3}, corresponding to the positive components in the Fiedler vector 207, and the other component 102 with vertices {4,5} corresponding to the negative components in the Fiedler vector 207.

A key limitation of the conventional spectral clustering approach is fundamentally imbedded in its definition based on the weights of graph edges, which must be nonnegative, for example, when the construction is based on the distance, describing quantitative assessment of the relative similarity of each pair of points in the dataset. The nonnegative weights of the graph edges lead to the graph adjacency matrix A with nonnegative entries.

In many practical problems, e.g., in anomaly detection for time series, data points represent feature vectors or functions, allowing the use of correlation for their pairwise comparison. However, the correlation can be negative, i.e., more generally, points in the dataset can be dissimilar, contrasting each other e.g., such that one quantity increases when another quantity decreases.

In the conventional spectral clustering the only available possibility to handle such a case is to replace the anticorrelation, i.e., with negative correlation, of the data points with the uncorrelation, i.e., with zero correlation. The replacement changes the corresponding negative entry in the graph adjacency matrix to zero, to enable the conventional spectral clustering to proceed, but nullifies a valid comparison. Therefore, there is a need to provide a data clustering spectral partitioning method that works directly with correlated and uncorrelated data, and with anticorrelated data, represented by the graph adjacency matrix A having negative entries as well as nonnegative entries.

Graph Signal Processing

A wide range of applications in signal processing exhibit data that can be represented on vertices of graphs that describe a geometric structure of the data. These applications include social, energy, and transportation structures, and sensor network, as well as synthetic and natural images, videos, and medical and hyper-spectral images. Graph signal processing tools have been used in conventional image and video processing applications.

For example, for image processing applications, a pixel in an image can be treated as a node in a graph, while weights on edges connecting the nodes represent a measure of similarity of the pixels connected by the edges. All pixels within the image, or an image slice, share a single graph and are processed within one graph spectral domain. After the connection structure in the graph is defined, a weight wᵢⱼ≧0 is assigned for each graph edge, often using spatial and intensity distance penalties.

An adjacency matrix A of the graph is a symmetric N×N matrix having entries aᵢⱼ=wᵢⱼ≧0, and a diagonal degree matrix is D:={d₁, d₂, . . . , d_{N}}. A graph Laplacian matrix L=D−A is symmetric positive semi-definite, thus admitting an eigendecomposition L=UΛU^{T}, where U is an orthogonal matrix with columns forming an orthonormal set of eigenvectors, and Λ=diag {λ₁, . . . , λ_{N}} is a matrix made of corresponding eigenvalues, all nonnegative.

The eigenvalues and eigenvectors of the Laplacian matrixes provide a spectral interpretation of graph signals, where the einenvalues can be treated as graph Fourier frequencies, and the eigenvectors as generalized Fourier modes. Graph spectral filtering [symbol] can be designed for image processing purposes in the graph spectral domain, where [symbol] is a diagonal matrix, typically given as [symbol] =h(Λ), where h(λ) is a real valued function of a real variable λ, determining the filter. The corresponding graph filter n in the vertex domain can be expressed as H=h(L)=U [symbol] U^{T}.

The graph adjacency matrix A and the graph Laplacian matrix L for graph signal processing and for the purpose of data clustering via spectral partitioning are constructed similarly and share the same limitation, resulted from the assumption that the graph weights must be nonnegative. There is a need to remove the limitation by eliminating the assumption, to allow data comparison methods producing both positive and negative similarities to be used for graph based data processing.

### SUMMARY OF THE INVENTION

The embodiments of the invention provide a method for processing input data. The input data consist of data points, and each data point is an element in the data. A Laplacian matrix is determined for the data. The Laplacian matrix can be determined as a graph Laplacian matrix. The Laplacian matrix has an attractive spectrum of positive eigenvalues, a repulsive spectrum of negative eigenvalues, and a neutral spectrum of zero eigenvalues.

Conventional graph based data processing methods use the Laplacian matrix with only a nonnegative spectrum, which makes them unsuitable for many applications where negative similarities are possible and desirable. Therefore, the invention is based on a realization that the quality of data processing is improved when the negative spectrum is allowed in the Laplacian matrix.

The method continues by determining an operation for the processing of the data using the Laplacian matrix, and using information about the attractive spectrum, the repulsive spectrum, and the neutral spectrum. The information includes the spectra and properties derived from the spectra, such as, for example, largest or smallest values in the spectra, number of eigenvalues present in the spectra, or eigenvalue density in the spectra. Then, the method performs the operation on the input data to produce processed data as an output.

The main realization for the invention comes from analyzing a mechanical vibration model. In a spring-mass system, the masses that are tightly connected have a tendency to move synchronically in low-frequency free vibrations. Analyzing the signs of the components corresponding to different masses of the low-frequency vibration modes of the system allows one to determine the clusters.

The mechanical vibration model may describe conventional clustering when all the springs are pre-tensed to create an attracting force between the masses. The invention is based on the realization that one can also pre-tense some of the springs to create a repulsive force between the two masses. In the context of data clustering formulated as graph partitioning, that corresponds to negative entries in the adjacency matrix. The negative entries in the adjacency matrix are not allowed in conventional graph spectral clustering. However, the model of mechanical vibrations of the spring-mass system with repulsive springs is valid, for the purpose of the invention.

In the spring-mass system, the masses, which are attracted, have the tendency to move together synchronically in the same direction in low-frequency free vibrations, while the masses, which are repulsed, have the tendency to move synchronically in the opposite direction. The repulsive forces create a new phenomenon of existence of unstable standing waves repulsing some masses apart. The repulsive phenomenon is advantageous, increasing the quality of data processing by distinguishing data points having negative similarities.

Key application fir the method include cluster analysis, predictive analysis, pattern recognition, association rule learning, anomaly detection, classification, modeling, summarization, sampling, as well as signal quality improvement, filtering, compression, sampling, feature extraction, and signal noise reduction.

### BRIEF DESCRIPTION OF THE DRAWINGS

FIGS. 1 and 2 are schematics of prior art clustering;

FIG. 3 is a flow diagram of a method for processing data using a spectrum of a Laplacian matrix according to embodiments of the invention; and

FIG. 4 is a schematic of a spectrum of the Laplacian matrix according to embodiments of the invention;

FIG. 5 is a flow diagram of a method for clustering data points according to embodiments of the invention;

FIGS. 6A and 6B compare a prior art graph bisection with a graph bisection according to embodiments of the invention.

FIG. 7 is a schematic of a vibration model of a wave equation using quasiparticles according to embodiments of the invention;

FIG. 8 is a schematic of a vibration model with attractive and repulsive springs according to embodiments of the invention; and

FIGS. 9 and 10 schematically compare displacement of clusters of masses using the prior art mass-spring model, and the model according to embodiments of the invention.

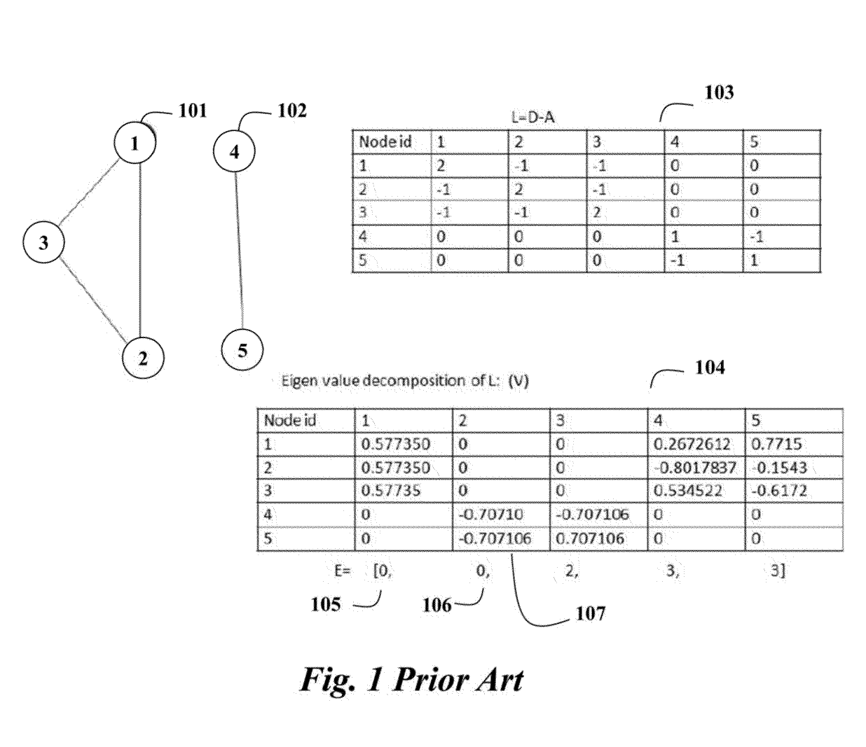

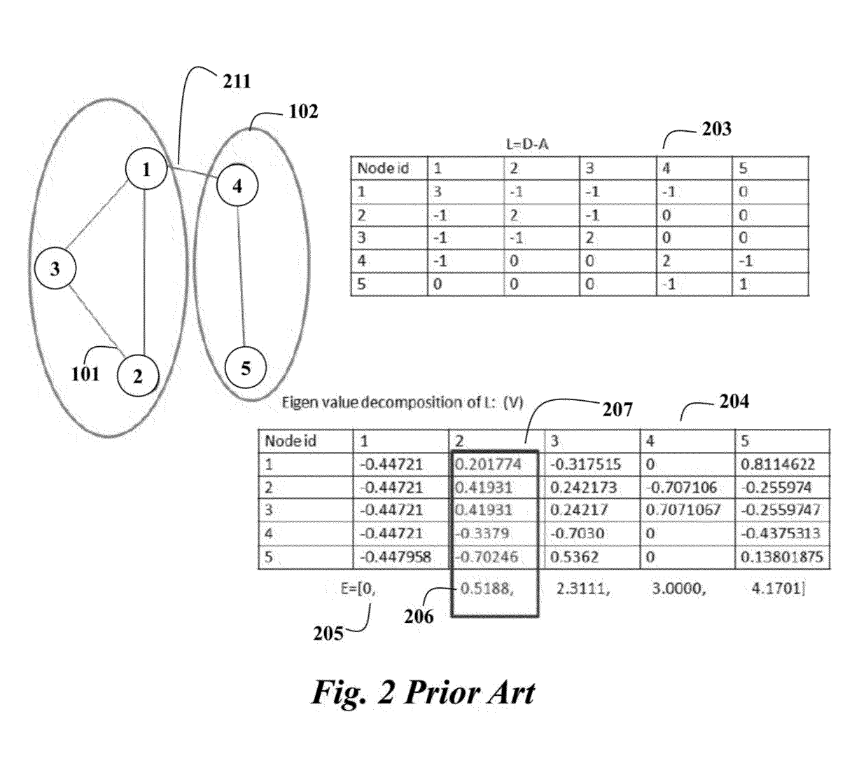

### DETAILED DESCRIPTION OF THE PREFERRED EMBODIMENTS

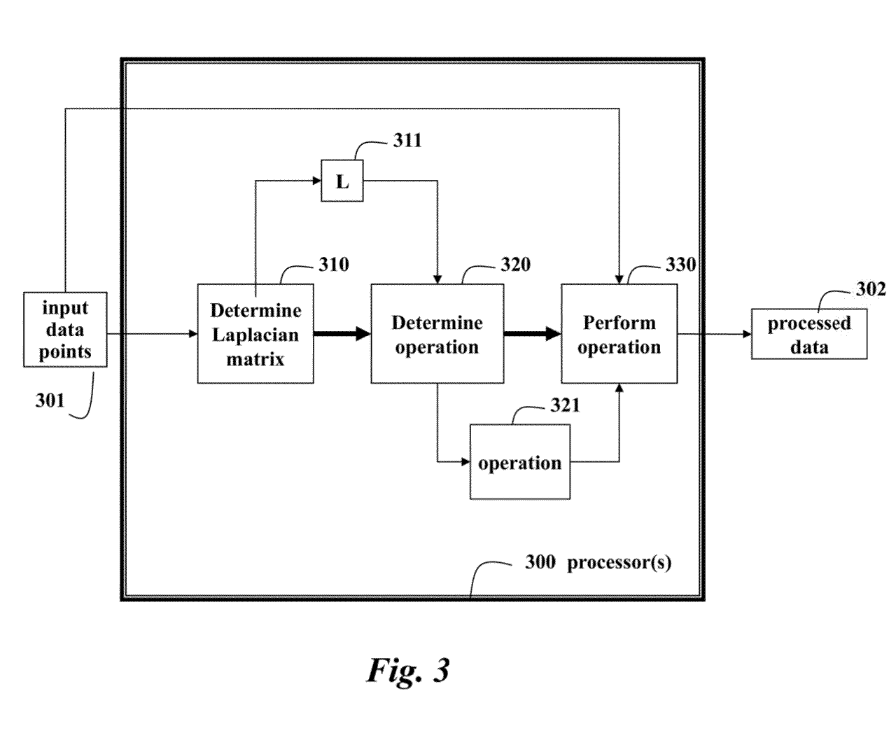

As shown in FIG. 3, the embodiments of the invention provide a method for processing input data 301, wherein the input data consist of data points, and wherein each data point is an element in the data.

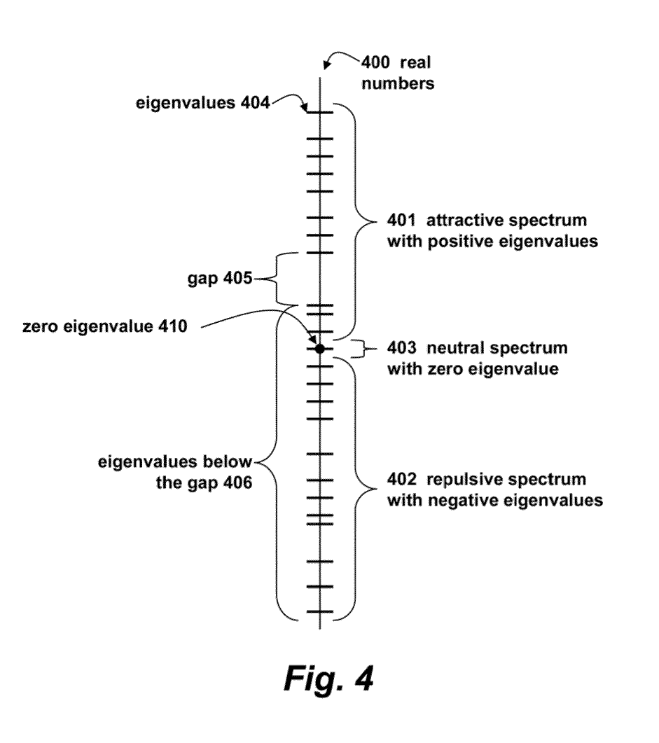

The method determines 310 a Laplacian matrix L 311 for the data. The details of the spectrum are described with reference FIG. 4. Conventional graph based data processing uses the Laplacian matrix with only a nonnegative spectrum. The invention is based on a realization that the quality of data processing is improved when a negative spectrum is also allowed.

Then, an operation 321 for the processing the data using the Laplacian matrix is determined 320 using information about the attractive spectrum, the repulsive spectrum, and the neutral spectrum, see FIG. 4 for details, wherein the information includes the spectra and properties derived from the spectra, such as, for example, largest or smallest values in the spectra, number of eigenvalues present in the spectra, or eigenvalue density in the spectra.

Having the operation determined, the operation on the input data 301 is then performed to produce processed data 302, which are the output of the method. The steps can be performed in one or more computer processors connected to memory and input/output interfaces by buses as known in the art.

Spectrum of the Laplacian Matrix

FIG. 4 is a schematic of the spectrum of the Laplacian matrix L. The spectrum is defined as eigenvalues 404, on the line of real numbers 400. The Laplacian matrix L is symmetric, thus the eigenvalues are all real. The spectrum includes an attractive spectrum 401 of positive eigenvalues, a repulsive spectrum 402 of negative eigenvalues, and a neutral spectrum 402 of zero eigenvalues. The neutral spectrum 403 consist of possibly multiple eigenvalue all equal to the number zero 410. The attractive spectrum has a gap 405, wherein eigenvalues 406 are below the gap.

Two key application types are identified for the method. The first type is data processing for the purpose of one or a combination of cluster analysis, predictive analysis, pattern recognition, association rule learning, anomaly detection, classification, modeling, summarization, sampling, and compression. This description concentrates on cluster analysis and anomaly detection, as examples of data processing of the first type.

The second type of applications comprises the cases, where the data are signals and the processing of the signals is selected from the group consisting of quality improvement, filtering, sampling, compression, and feature extraction, and combinations thereof. Examples of data processing of the second type are provided, comprising signal noise reduction as a specific example of the data quality improvement, and the signal filtering, both of which are graph based.

In one embodiment, the Laplacian matrix L is determined as a graph Laplacian matrix, wherein the graph Laplacian matrix is determined for the data represented using a graph. A typical example of the graph representing the data is when the data points represent graph vertices, and graph edges are associated with weights of the graph edges. The weights of the graph edges serve as entries in a graph adjacency matrix A representing mutual pairwise comparing of every data point with each other data point.

An Undirected graph G=(V,E) includes a set of vertices, also called nodes, V={1, 2, . . . , N} connected by a set of edges E={(i,j,wᵢⱼ)}, i, j∈V, where (i,j, wᵢⱼ) denotes an edge between nodes i and j associated with a weight wᵢⱼ which can be positive, zero, or negative. The presence of the negative weights is a main distinction from the prior art, where all the weights must be nonnegative. A degree dᵢ of a node i is a sum of edge weights connected to the node i. Because of the negative weights, at least some degrees may be zero, so a conventional normalized graph Laplacian matrix, based on inverting of the degrees, cannot be defined.

In a further embodiment, the graph adjacency matrix for the data is determined using entries of the graph adjacency matrix, and the entries are determined by pairwise comparing every data point with each other data point, wherein the entry is positive for a similar pair of data points, negative for a disparate pair of data points, and zero for an uncorrelated pair of data points, and wherein an amplitude of the entry quantifies a level of the similarity when positive, and a disparity when negative.

Next, the graph Laplacian matrix is determined by subtracting the graph adjacency matrix from a graph degree matrix, wherein the graph degree matrix is determined as a diagonal matrix, wherein every diagonal entry of the diagonal matrix is a row sum of the graph adjacency matrix in the same row with the diagonal entry.

A spectral partitioning method, which can directly deal with negative entries in the graph adjacency matrix A, is described. This method uses a symmetric similarity matrix A to form the graph Laplacian L=D−A of the graph whose vertices correspond to the individual variables in the problem domain, and the edges between two variables i and j have weight aᵢⱼ. In contrast to the conventional method, the weight aᵢⱼ can be negative.

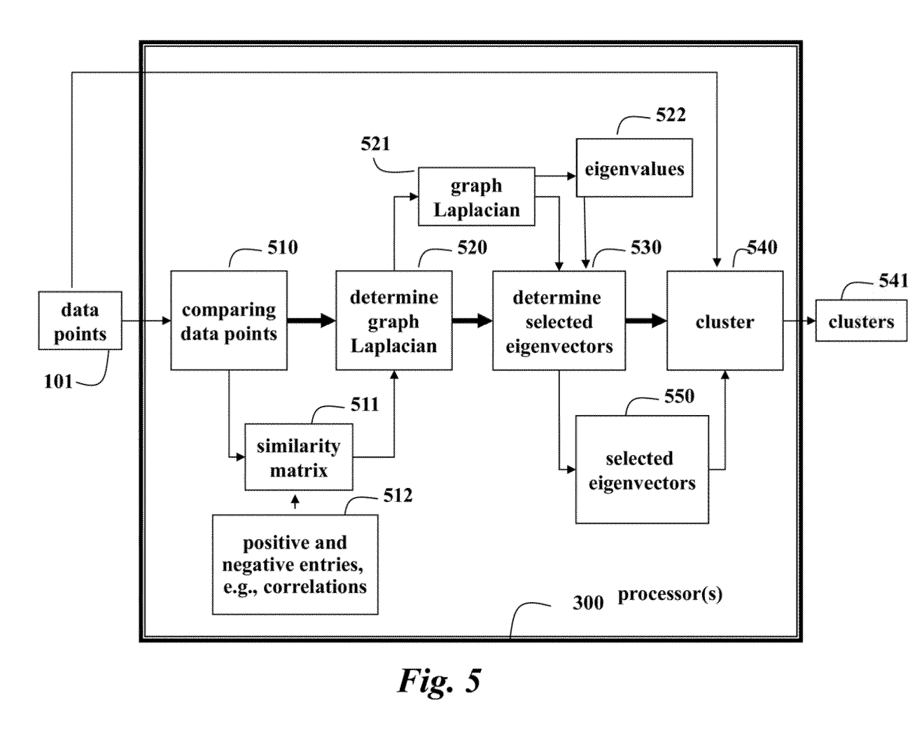

FIG. 5 shows a method for clustering the data points 101 according to embodiments the invention. The data points are compared 510 with each other pairwise to determine a pairwise similarity matrix 511 with positive and negative entries 512, for example determined as correlations of the data points. The similarity matrix is used as a graph adjacency matrix A to determine a graph Laplacian matrix L 521 with eigenvalues 522. Eigenvectors 550 for selected eigenvalues are determined 530. Then, the data points are clustered 540 into clusters 541 using the selected eigenvectors 550, for example, using the signs of components of the selected eigenvectors 550. The method can be performed in the processor(s) 300.

The described in FIG. 5 clustering method, which allows nonnegative and the negative entries in the graph adjacency matrix, is advantageous because situations where the pair of data points is disparate can be explicitly represented in the graph adjacency matrix, thus improving the quality of the fluffier data processing. In the prior art, the entries in the graph adjacency matrix must be all nonnegative, which does not admit negative data comparisons, available in many practical applications,

For example, a practically important case is where the data points are feature vectors of some underlining original data, or just vectors themselves. In one embodiment, the pair-wise comparing of data points is determined based on a correlation or a covariance, wherein the correlation and the covariance quantify a linear dependence between the vectors, such that the entry of the graph adjacency matrix is positive, negative, or zero, depending on whether the two vectors are positively correlated, negatively correlated, or uncorrelated. This embodiment is advantageous because it directly uses the correlation or the covariance for data comparing, even when the correlation or the covariance is negative for at least some pairs of the data points, thus potentially improving the quality of the fluffier data processing. In the prior art, the vectors would be typically be compared using a kernel distance function leading to the graph adjacency matrix with all nonnegative entries.

In another embodiment, the vectors are feature vectors for time series data, which is one of practically important examples of data processing. For example, it is common to detect anomalies in time series data.

The graph adjacency matrix having both positive and negative entries can lead to the graph Laplacian having positive and negative eigenvalues. In contrast, the conventional graph Laplacian is nonnegative definite having only nonnegative eigenvalues, because only nonnegative values are allowed in the conventional graph adjacency matrix in conventional graph based data processing. The presence of the repulsive spectrum of the negative eigenvalues of the graph Laplacian is not possible in the conventional approach creating a need to change conventional tools used in conventional graph based data processing.

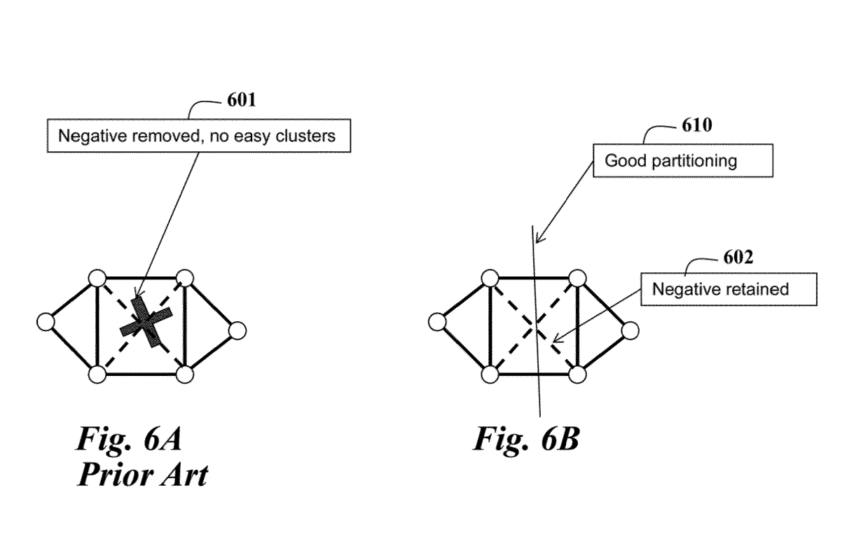

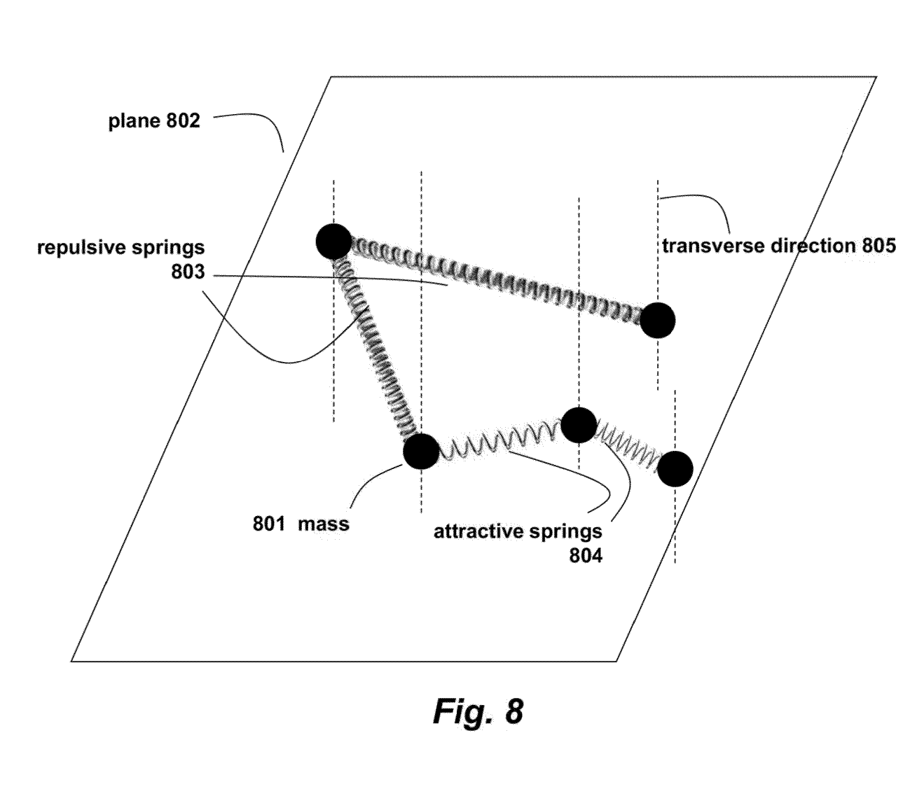

FIGS. 6A and 6B compare the prior art graph bisection with the graph bisection according to embodiments of the invention. In the prior art FIG. 6A graph edges with negative weights are removed 601, because negative entries in the adjacency matrix are not allowed in the prior art, and need to be replaced with zeroes. Having the graph edges with the negative weights in the graph retained 602 the negative eigenvalues lead to a good partitioning 610, because the graph edges with negative weights repulse the partitions, see FIG. 8 for details.

The invention is partially based on the realization that when the graph Laplacian has the repulsive spectrum of the negative eigenvalues, the graph can be described using models. Two examples of the models are considered: a vibration model of a wave equation, and a concentration-diffusion model of a diffusion equation.

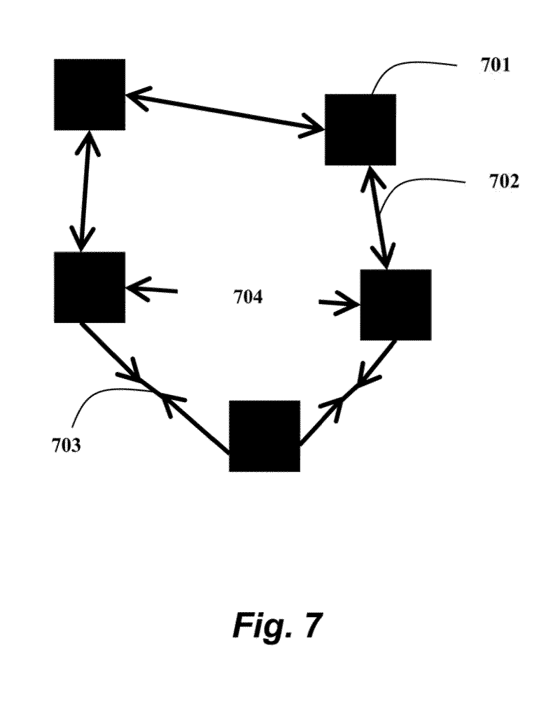

As shown in FIG. 7, in one embodiment, the determining of the Laplacian matrix is based on the vibration model of a wave equation. The determining comprises the steps of determining the vibration model representing the data, wherein the vibration model is a description of a system made of interacting quasiparticles 701 subjected to vibrations, each quasiparticle of the vibration model corresponds to one of the data points, and interaction coefficients of the vibration model are determined by pair-wise comparison of the data points, wherein the interacting is attractive 703 and the interaction coefficient is positive if the data points in the pair are similar, or the interacting is absent 704 and the interaction coefficient is zero when the data points in the pair are not comparable, or the interacting is repulsive 702 and the interaction coefficient is negative when the data points in the pair are disparate, and wherein a strength of the interacting and an amplitude of the interaction coefficient represent a level of similarity or disparity; determining eigenmodes of the vibration model of the wave equation, wherein the eigenmodes are eigenvectors of an eigenvalue problem; and determining the Laplacian matrix horn the eigenvalue problem.

As shown in FIG. 8, in a different embodiment, the vibration model represents a mass-spring system consisting of masses 801 and spring 803, 804, wherein the mass is the quasiparticle and a stiffness of the spring is determined by the interaction of the masses, wherein the attractive spring 804 attracts the two masses when interaction is attractive, and the repulsive spring 803 repulses the two masses when the interaction is repulsive; and the mass-spring system is subject to transverse vibrations, wherein the transverse vibrations enable the masses to move only in a transverse direction 805 perpendicular to a plane 802 of the mass-spring system.

A different embodiment represents the second, alternative, model, wherein the determining of the Laplacian matrix is based on the concentration-diffusion model of the diffusion equation, further comprising the steps of determining the concentration-diffusion model of the diffusion equation representing the data, wherein the concentration-diffusion model is a system made of interacting quasiparticles subjected to concentration or diffusion, each quasiparticle of the concentration-diffusion model corresponds to a point in the data, and the model quasiparticle interaction conductivity coefficients are determined by pair-wise comparison of data points, wherein the interaction is diffusive and the interaction conductivity coefficient is positive if the data points in the pair are similar, or the interaction is absent and the interaction conductivity coefficient is zero, if the data points in the pair are not comparable, or the interaction is concentrative and the interaction conductivity coefficient is negative, if the data points in the pair are disparate, and wherein the strength of the interaction and the amplitude of the interaction coefficient represent the level of similarity or disparity; determining eigenmodes of the concentration-diffusion model of the diffusion equation, wherein the eigenmodes are eigenvectors of the eigenvalue problem; determining the Laplacian matrix as the matrix of the eigenvalue problem.

It is realized realize that, despite being very different, the vibration model of the wave equation and the concentration-diffusion model of the diffusion equation determination of their eigenmodes, also sometimes called standing waves, can be reduced to the same eigenvalue problem, after separating temporal and spatial variables.

Thus, in another embodiment, the Laplacian matrix in the vibration model of the wave equation and in the concentration-diffusion model of the diffusion equation can be determined as a graph Laplacian matrix, wherein the graph Laplacian matrix is determined for the data represented using the graph, thus connecting the models to the graph based data processing. This realization allows us to determine how to treat the repulsive spectrum in the Laplacian matrix for the purpose of data processing based on the analysis of time-dependent behavior of a solution of any of the two models.

For example, in the vibration model of the wave equation any eigenmode corresponding to a negative eigenvalue in the repulsive spectrum contributes to increasing the amplitudes of vibrations of components when the interaction between the components is repulsive. The increasing of the amplitudes of vibrations of the components is an indication that the components are not likely to appear in the same cluster, for the purpose of data clustering. The increasing is advantageous because it makes the determining of clusters simpler. This argument also suggests that the repulsive spectrum is more important compared to the attractive spectrum or even the neutral spectrum, and thus should be treated preferentially in the upcoming embodiments related to the clustering.

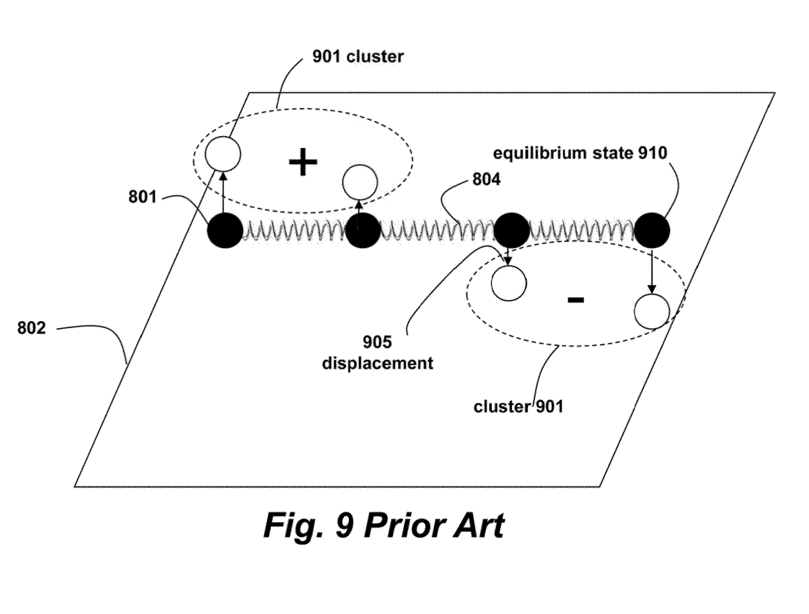

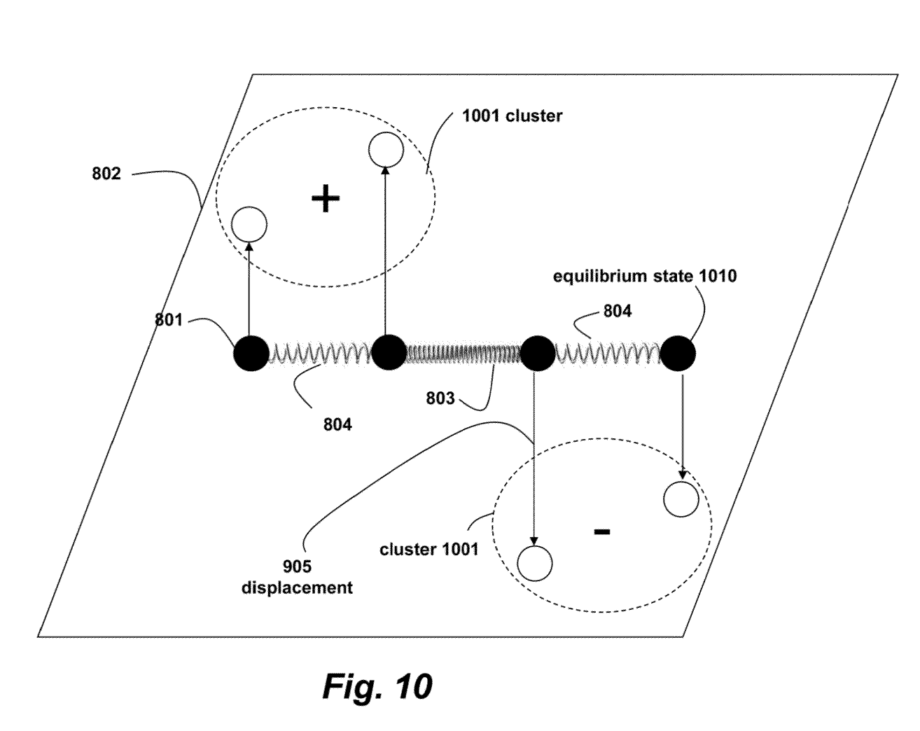

The advantageous increase of the amplitudes of vibrations of the components of repulsive eigenmodes for the purpose of data partitioning is shown in FIGS. 9 and 10. FIGS. 9 and 10 are complementary to FIGS. 6A and 6B, respectively. FIG. 9 shows the prior art vibration model with only attractive springs 804. The displacement 905 of the masses 801 from the equilibrium state 910 in the middle of the system is relatively small, so the clusters 901 are difficult to detect.

In FIG. 10, the repulse spring 803 increases the displacement of the masses from the equilibrium state 1010 in the middle of the system, and hence the clusters 1001 are easier and more reliable to detect compared to the prior art clusters 901.

The possibility of imposing one or more constraints on the eigenvectors of the graph Laplacian matrix are further described, wherein the one or more constraints is a one or a combination of setting specific eigenvector components to zero, imposing sparsity of eigenvector components, and requiring that the eigenvector is perpendicular to a set of given vectors. It is advantageous to have the constraints, because the constraints give the data scientist an opportunity to incorporate semi-supervised data learning into the graph based data processing. For example, the constraints may be obtained from a data processing procedure previously performed on similar data.

Next, several embodiments of determining of the operation of the data processing are briefly summarized, based on the realization that various spectra of the Laplacian matrix need to be treated differently. In one embodiment, the determining of the operation further comprises the steps of determining selected eigenvalues and corresponding eigenvectors of the Laplacian matrix, wherein the selected eigenvalues are based on one or a combination of the attractive spectrum, the repulsive spectrum, the neutral spectrum, targeted eigenvalues of the attractive spectrum, and targeted eigenvalues of the repulsive spectrum, targeted eigenvalues of the neutral spectrum, and finally, determining the operation using the Laplacian matrix and the selected eigenvalues and the corresponding eigenvectors of the Laplacian matrix. The eigenvalues are targeted according to the needs of the specific operation of the data processing. For example, fur a low-pass graph based filtering of the data representing signals, the targeted eigenvalues are 406 the smallest, below the gap 405 using a band threshold, eigenvalues of the Laplacian matrix, starting with the repulsive spectrum when present as shown in FIG. 4.

A further embodiment determines the operation, using one or a combination of a projection on a subspace determined by the selected eigenvectors, and an iterative method to improve approximations to the selected eigenvectors.

The subspace, for example, may be an approximation to a span of the selected eigenvectors, corresponding to the targeted eigenvalues. The key to the efficiency of this procedure is the fast determination of the targeted eigenvalues of the matrix L. This can be done, for example, by means of a Lanczos or Locally Optimal Block Preconditioned Conjugate Gradient (LOBPCG) methods. The Lanczos and LOBPCG methods do not need the entire matrix L in memory, but only need the results from multiplying the matrix L by a given vector. This characteristic of the methods makes them applicable to eigenvalue analysis problems of very high dimensions, and eliminates the need to store the entire similarity matrix in memory, thus resulting in scalability to very large matrix sizes.

The iterative method, for example, is determined in another embodiment from the group consisting of a Krylov-based iterative method, an approximate a Krylov-based iterative method, a rational Krylov subspace, an approximate rational Krylov subspace, a subspace iterative method, and combinations thereof. The Krylov-based iterative method is advantageous, for example, because it can be implemented in a matrix-free fashion, requiring no storage of the Laplacian matrix, but rather only an access to a function that performs a product of the Laplacian matrix with a vector. The rational Krylov subspace, for example, is advantageous, because it allows for a high quality approximation of complicated filter functions.

For example, if one is interested in one or a combination of low-pass and high-pass filters, then one can use the Krylov subspace projection technique, wherein the order-(k+1) Krylov subspace is defined as K=span {b, Lb, . . . , L^{k}b}. The initial vector b may for example be the input signal. The Krylov subspace can approximate well eigenvectors corresponding to extreme eigenvalues, thus it is an appropriate choice for high- and low-pass filters.

The filter can also be constructed based on rational Krylov subspaces and their approximations. A rational Krylov subspace Kᵣ, defined as

Kr=span{(L−s₁I)⁻¹b, . . . , IIⱼ(L−sⱼI)⁻¹b},

estimates well interior, as opposed to extreme, eigenvalues thereby allowing for the design of band pass and band reject filters.

Another important embodiment determines parameters of the iterative method based on the selected eigenvalues. This is advantageous, because the eigenvalues are determined from the data, which makes the parameters of the iterative method to flexibly adjust to the data, thus possibly increasing the performance of the operation in terms of both speed and quality.

An example of an optimal polynomial low pass filter is based on Chebyshev polynomials. Specifically, one can use a degree k Chebyshev polynomial h_{k-CHEB} with a stop band over the interval [a, b]. The construction of a Chebyshev polynomial can, for example, be obtained by determining the roots of the degree k Chebyshev polynomial \hat{r}(i)=cos(π(2i−1)/2k) for i=1 . . . k over the interval [−1,1], then shifting the roots to the interval [a, b] using a linear transformation to obtain the roots rᵢ of the polynomial h_{k-cHEB}, and compute the processed signal x*_{K} by evaluating xⁱ=rᵢxⁱ⁻¹−Lxⁱ⁻¹ iteratively for i=1, . . . , k, where x⁰ is the input signal. The novelty in the example based on Chebyshev polynomials is that the Laplacian matrix L is not positive semidefinite, so one needs to be careful in the choice of the interval [a, b]. In the prior art, the spectrum of the Laplacian matrix L is always nonnegative and, if the Laplacian is normalized, bounded by 2. When the repulsive spectrum of L is present, one cannot generally also normalize the Laplacian. Bounds on the whole spectrum of L are taken into account, including the repulsive spectrum consisting of negative eigenvalues, determining the value of the end points of the interval [a, b] in the filter design. For example, designing the filter to amplify the eigenmodes corresponding to the repulsive spectrum, and set a=0, and determine the value of b as an upper bound for the attractive spectrum of the Laplacian matrix L.

The next series of embodiments deals with the cluster analysis. The repulsive spectrum should be given a preference, compared to the neutral spectrum, and even more so compared to the attractive spectrum. Thus, in one embodiment, the determining the operation further, comprises the steps of: determining eigenvalues of the Laplacian matrix selected from the group consisting of all or smallest eigenvalues of the repulsive spectrum, all or part of the neutral spectrum, and the smallest eigenvalues of the attractive spectrum, and combinations thereof; determining a gap 406 in the selected eigenvalues, using a threshold; determining a set of the eigenvectors of the Laplacian matrix corresponding to the selected eigenvalues located below the gap; determining pre-clusters in the data by analyzing signs and amplitudes of components of the eigenvectors in the set of the eigenvectors, wherein data points are assigned to the same pre-cluster when the corresponding components are similar, for example, using k-means clustering; and determining the clusters by analyzing a connectivity the graph of the pre-clusters, wherein the data points are assigned to the same cluster when the data points are connected in a sub-graph, determined by the pre-cluster.

The method for determining the pre-clusters bodes well with the intuition: in the spring-mass system the masses, which are attracted have the tendency to move together synchronically in the same direction in low-frequency free vibrations, while the masses which are repulsed have the tendency to move synchronically in the opposite direction. The realization of the existence of unstable eigenmodes repulsing the masses apart, having the repulsive forces, is not available in state-of-the-art, because the unstable eigenmodes correspond to negative eigenvalues of the Laplacian matrix, in contrast to the conventional approach where all eigenvalues of the Laplacian matrix are nonnegative by design.

In contrast to the prior art, the presence of the repulsive spectrum may result in pre-clusters, which may be not connected. An additional step, determining the clusters as connected components of the pre-clusters, is needed. A different novelty of the proposed embodiments is the fact that the diagonal degree matrix may have zero values on its diagonal, making the formulation of the conventional normalized-cuts Shi-Malik method fail because the conventional normalized graph. Laplacian matrix cannot be defined.

A single application of the operation may not give enough clusters, so a different embodiment suggests repeating the method recursively by treating every cluster as new data until a terminations condition is reached using one or a combination of a predetermined number of recursive steps and a threshold on the size of the cluster.

Another embodiment deals with one important particular example of the method, wherein there is only one eigenvalue below the gap and the corresponding eigenvector is the only eigenvector in the set of eigenvectors having components of both positive and negative signs. In this case, the pre-cluster is determined by grouping components with the same sign, thus providing a specific example of determining the similarity of the components.

In some application, the clusters are not required to be exclusive; instead, it is desired to determine a probabilistic description of the clusters. One embodiment determines a matrix of probabilities of the data points to belong to the clusters, wherein every column in the matrix represents probabilities of the data points to belong to every cluster, and wherein a column range of the matrix approximates a span of the set of the eigenvectors of the Laplacian matrix.

One or a combination of the steps can be performed using one or more computer processors, including a combination of at least one processor, multi-core computer processor unit, graphics processing unit, field-programmable gate array, and dedicated parallel computer clusters.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

I claim:

1. A method for processing input data, wherein the input data consist of data points, wherein each data point is an element in the data, comprising the steps of:
determining a Laplacian matrix for the data, wherein a spectrum of the Laplacian matrix includes an attractive spectrum of positive eigenvalues, a repulsive spectrum of negative eigenvalues, and a neutral spectrum of zero eigenvalues;
determining an operation for the processing using the Laplacian matrix, using information about the attractive spectrum, the repulsive spectrum, and the neutral spectrum, wherein the information includes the spectra and properties derived from the spectra;
performing the operation to produce processed data; and
outputting the processed data, wherein the steps are performed using one or more processors.

2. The method of claim 1, wherein the processing is one or a combination of cluster analysis, predictive analysis, pattern recognition, association rule learning, anomaly detection, classification, modeling, summarization, sampling, and compression.

3. The method of claim 1, wherein the data are signals and the processing of the signals is selected from the group consisting of quality improvement, filtering, sampling, compression, and feature extraction, and combinations thereof.

4. The method of claim 1, wherein the Laplacian matrix is a graph Laplacian matrix, and wherein the graph Laplacian matrix is determined for the data represented using a graph, comprising the steps of:
determining a graph adjacency matrix for the data, wherein the graph adjacency matrix is determined using entries of the graph adjacency matrix, and the entries are determined by pairwise comparing every data point with each other data point, wherein the entry is positive for a similar pair of data points, negative for a disparate pair of data points, and zero for an uncorrelated pair of data points, and wherein an amplitude of the entry quantifies a level of the similarity when positive, and a disparity when negative; and
determining the graph Laplacian matrix by subtracting the graph adjacency matrix from a graph degree matrix, wherein the graph degree matrix is determined as a diagonal matrix, wherein every diagonal entry of the diagonal matrix is a row sum of the graph adjacency matrix in the same row with the diagonal entry.

5. The method of claim 4, wherein the data points are vectors and the pair-wise comparing of data points is determined based on a correlation or a covariance, wherein the correlation and the covariance quantify a linear dependence between the vectors, such that the entry of the graph adjacency matrix is positive, negative, or zero, depending on whether the two vectors are positively correlated, negatively correlated, or uncorrelated.

6. The method of claim 5, wherein the vectors are feature vectors for time series data.

7. The method of claim 1, wherein the determining of the Laplacian matrix and of the operation is based on a vibration model of a wave equation, comprising the steps of:
determining the vibration model representing the data, wherein the vibration model is a description of a system made of interacting quasiparticles subjected to vibrations, each quasiparticle of the vibration model corresponds to one of the data points, and interaction coefficients of the vibration model are determined by pairwise comparison of the data points, wherein the interacting is attractive and the interaction ;coefficient is positive if the data points in the pair are similar, or the interacting is absent and the interaction coefficient is zero when the data points in it the pair are not comparable, or the interacting is repulsive and the interaction coefficient is negative when the data points in the pair are disparate, and wherein a strength of the interacting and an amplitude of the interaction coefficient: represent a level of similarity or disparity;
determining eigenmodes of the vibration model of the wave equation, wherein the eigenmodes are eigenvectors of an eigenvalue problem;
determining the Laplacian matrix from the eigenvalue problem; and
determining the operation based on approximate solution of the model.

8. The method of claim 7, wherein
the vibration model represents a mass-spring system consisting of masses and springs, wherein the mass is the quasiparticle and a stiffness of the spring is determined by the interaction of the masses, wherein the spring attracts the two masses when interaction is attractive, and the spring repulses the two masses when the interaction is repulsive; and
the mass-spring system is subject to transverse vibrations, wherein the transverse vibrations enable the masses to move only at a direction perpendicular to a plane of the mass-spring system.

9. The method of claim 1, wherein the determining of the Laplacian matrix and of the operation is based on a concentration-diffusion model of a diffusion equation, and further comprising the steps of:
determining the concentration-diffusion model of the diffusion equation representing the data, wherein the concentration-diffusion model is a system made of interacting quasiparticles subjected to concentration or diffusion, each quasiparticle of the concentration-diffusion model corresponds to a point in the data, and the model quasiparticle interaction conductivity coefficients are determined by pair-wise comparison of data points, wherein the interaction is diffusive and the interaction conductivity coefficient is positive if the data points in if the pair are similar, or the interaction is absent and the interaction conductivity coefficient is zero, if the data points in the pair are not comparable, or the interaction is concentrative and the interaction conductivity coefficient is negative, if the data points in the pair are disparate, and wherein the strength of the is interaction and the amplitude of the interaction coefficient represent the level of similarity or disparity;
determining eigenmodes of the concentration-diffusion model of the diffusion equation, wherein the eigenmodes are eigenvectors of the eigenvalue problem;
determining the Laplacian matrix as the matrix of the eigenvalue problem; and
determining the operation based on approximate solution of the model.

10. The method of claim 7 or 9, wherein the Laplacian matrix is a graph Laplacian matrix, and wherein the graph Laplacian matrix is determined for the data represented using the graph.

11. The method of claim 10, further comprising:
imposing one or more constraints on the eigenvectors of the graph Laplacian matrix, wherein the one or more constraints is a one or a combination of:
setting specific eigenvector components to zero;
imposing sparsity of eigenvector components; and
requiring that the eigenvector is perpendicular to a set of given vectors.

12. The method of claim 1, wherein the determining of the operation further comprising the steps of:
determining selected eigenvalues and corresponding eigenvectors of the Laplacian matrix, wherein the selected eigenvalues are based on one or a combination of the attractive spectrum, the repulsive spectrum, the neutral spectrum, targeted eigenvalues of the attractive spectrum, and targeted eigenvalues of the repulsive spectrum, targeted eigenvalues of the neutral spectrum; and
determining the operation using the Laplacian matrix and the selected eigenvalues and the corresponding eigenvectors of the Laplacian matrix.

13. The method of claim 12, wherein the operation is determined, using one or a combination of a projection on a subspace determined by the selected eigenvectors, and an iterative method to improve approximations to the selected eigenvectors.

14. The method of claim 13, wherein the iterative method is determined from the group consisting of a Krylov-based iterative method, an approximate Krylov-based iterative method, a rational Krylov subspace, an approximate rational Krylov subspace, a subspace iterative method, and combinations thereof.

15. The method of claim 12, wherein parameters of the iterative method are determined based on the selected eigenvalues.

16. The method of claim 2, wherein the cluster analysis determines clusters, and the determining the operation further, comprises the steps of:
determining eigenvalues of the Laplacian matrix selected from the group consisting of all or smallest eigenvalues of the repulsive spectrum, all or part of the neutral spectrum, and the smallest eigenvalues of the attractive spectrum, and combinations thereof;
determining a gap in the selected eigenvalues, using a threshold;
determining a set of the eigenvectors of the Laplacian matrix corresponding to the selected eigenvalues located below the gap;
determining pre-clusters in the data by analyzing signs and amplitudes of components of the eigenvectors in the set of the eigenvectors, wherein data points are assigned to the same pre-cluster when the corresponding components are similar; and
determining the clusters by analyzing a connectivity the graph of the pre-clusters, wherein the data points are assigned to the same cluster when the data points are connected in a sub-graph, determined by the pre-cluster.

17. The method of claim 16, further comprising:
repeating the method of claim 16 recursively by treating every cluster as new data until a terminations condition is reached using one or a combination of a predetermined number of recursive steps and a threshold on the size of the cluster.

18. The method of claim 16, wherein:
there is only one eigenvalue below the gap;
the corresponding eigenvector is the only eigenvector in the set of eigenvectors having components of both positive and negative signs; and
the pre-cluster is determined by grouping components with the same sign.

19. The method of claim 16, further comprising:
determining a matrix of probabilities of the data points to belong to the clusters, wherein every column in the matrix represents probabilities of the data points to belong to every cluster, and wherein a column range of the matrix approximates a span of the set of the eigenvectors of the Laplacian matrix.

20. The method of claim 1, wherein the one or more processors includes a combination of at least one processor, multi-core computer processor unit, graphics processing unit, field-programmable gate array, and dedicated parallel computer clusters.
